(19) United States
(12) Patent Application Publication
(10) Pub. No.: US 2006/0018519 A1
(43) Pub. Date: Jan. 26, 2006

(54) Hand-held personal identification device with distributed control system

(75) Inventors: William G. Siegel, Wellington, FL (US); Ronnie Leighty, Lutz, FL (US); Christian Liautaud, Boca Raton, FL (US); Aleksandr A. Sorokin, Hobe Sound, FL (US); Timothy S. McDow, Jupiter, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc., Palm Beach Gardens, FL (US)

(21) Appl. No.: 11/178,593

(22) Filed: Jul. 12, 2005

Related U.S. Application Data
(63) Continuation-in-part of application No. 11/097,124, filed on Apr. 4, 2005.
(60) Provisional application No. 60/588,388, filed on Jul. 16, 2004.
(60) Provisional application No. 60/689,251, filed on Jun. 10, 2005.

(51) Int. Cl. G06K 9/00

(52) U.S. Cl. 382/116

(57) ABSTRACT

A hand-held personal identification device is provided. The hand-held personal identification device includes a sensor system for gathering biometric information from individuals, a profiler system for developing profiles of individuals based on biometric information gathered from the sensor system, and a personal data assistant or similar computing device with a screen for providing a user interface and overall system control. A sensor system interface couples the sensor system to the computer module.

### CROSS REFERENCE TO RELATED APPLICATIONS

This application claims the benefit of both U.S. Provisional Patent Application No. 60/588,388, filed Jul. 16, 2004 (Atty. Docket No. 1823.1210000) and U.S. Provisional Patent Application No. 60/689,251, filed Jun. 10, 2005 (Atty. Docket No. 1823.1210001), and is a continuation-in-part of U.S. patent application Ser. No. 11/097,124, filed Apr. 4, 2005 (Atty. Docket No. 1823.1210004), each of which is incorporated herein in its entirety by reference.

### FIELD OF THE INVENTION

The present invention relates to biometrics, and more particularly, to a hand-held personal identification device.

### BACKGROUND OF THE INVENTION

Biometrics is the science of biological characteristic analysis. A biometric is a measurable, physical characteristic or personal behavioral trait used to recognize or verify the identity of a person.

Historically, biometric information was gathered using equipment at a fixed location, such as a police station or an immigration office. The role and use of biometrics in many different applications and sectors, however, continues to expand. Collecting biometric data and properly associating it with corresponding demographic or other personal data is increasingly needed. Increasingly, biometric information needs to be gathered from individuals at a wide variety of locations. This has increased the importance of portability and demands placed on portable biometric devices. For example, law enforcement officers seek to collect fingerprints and mug shots for suspects in a wide range of remote locations. Additionally, security personnel at airports would like to use biometric information gathered from employees circulating throughout an airport to verify employee identification and track employee whereabouts. Personnel record systems, access control systems, and visitor management systems often require biometric information such as facial images, fingerprints, and other personal data (e.g., name, address, account data, etc.). In practice, it is often desirable to collect this information using a portable device.

Existing devices to gather biometric information are often not suited for remote, in-field use. Conventional devices intended to be used in the field are often cumbersome and/or lack the ability to efficiently process and compile information in real time. Many conventional devices are limited to collecting a particular type of data and cannot accommodate fingerprints and facial images and personal data.

What is needed is a personal identification device that overcomes the limitations of available devices.

### SUMMARY OF THE INVENTION

The present invention is directed to a hand-held personal identification device. The hand-held personal identification device includes a sensor system for gathering biometric information from individuals, a profiler system for developing profiles of individuals based on biometric information gathered from the sensor system, and a personal data assistant or similar computing device with a screen for providing a user interface and overall system control. A sensor system interface couples the sensor system to the computing device.

In embodiments, the profiler system includes a profile developer that creates an individual profile or profile record by combining a biometric image with supplementary data. As used herein, profile is used broadly to represent any combination or compilation of biometric information with supplementary data related to the individual for which the biometric information pertains and to the environment or situation in which the profile was created.

There are numerous benefits associated with the use of a hand-held personal identification device. These include, but are not limited to, providing an efficient way to capture and process biometric information at remote locations, while supporting in-field use.

Further embodiments, features, and advantages of the invention, as well as the structure and operation of the various embodiments of the invention are described in detail below with reference to accompanying drawings.

### BRIEF DESCRIPTION OF THE FIGURES

The invention is described with reference to the accompanying drawings. In the drawings, like reference numbers indicate identical or functionally similar elements. The drawing in which an element first appears is indicated by the left-most digit in the corresponding reference number.

FIG. 1 is a block diagram of a hand-held personal identification device according to an embodiment of the invention.

FIG. 2 is a block diagram of the sensor system used with the personal identification device of FIG. 1.

FIG. 3 is a block diagram of the profiler system used with the personal identification device of FIG. 1.

FIG. 4 is a perspective view of a hand-held personal identification device according to an embodiment of the invention.

FIG. 5A is a second perspective view of the hand-held personal identification device of FIG. 4.

FIG. 5B is an end view of the hand-held personal identification device of FIG. 4.

FIG. 5C is a side view of the hand-held personal identification device of FIG. 4.

FIG. 6 is a schematic diagram depicting selected internal components of the hand-held personal identification device of FIG. 4.

FIG. 7A is a perspective view of a bottom portion of an enclosure for the hand-held personal identification device of FIG. 4.

FIG. 7B is a second perspective view of a bottom portion of an enclosure for the hand-held personal identification device of FIG. 4.

FIG. 7C is a perspective view of a top portion of an enclosure for the hand-held personal identification device of FIG. 4.

FIG. 8 is a flowchart of a method for capturing and analyzing personal identity information of an individual using a hand-held personal identification device according to an embodiment of the invention.

FIG. 9 is a block diagram of a distributed control system for a hand-held personal identification device according to an embodiment of the invention.

FIGS. 10 and 11 depict a flow chart that illustrates the steps of a method for obtaining identification data according to an embodiment of the invention.

FIGS. 12A and 12B are photographs that show perspective views of a hand-held personal identification device according to a further embodiment of the invention.

FIGS. 13A and B are photographs that show perspective views from left and right of a hand-held personal identification device with a protective sleeve and multiple toggle buttons according to a further embodiment of the invention.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

A. Hand-Held Personal Identification Device

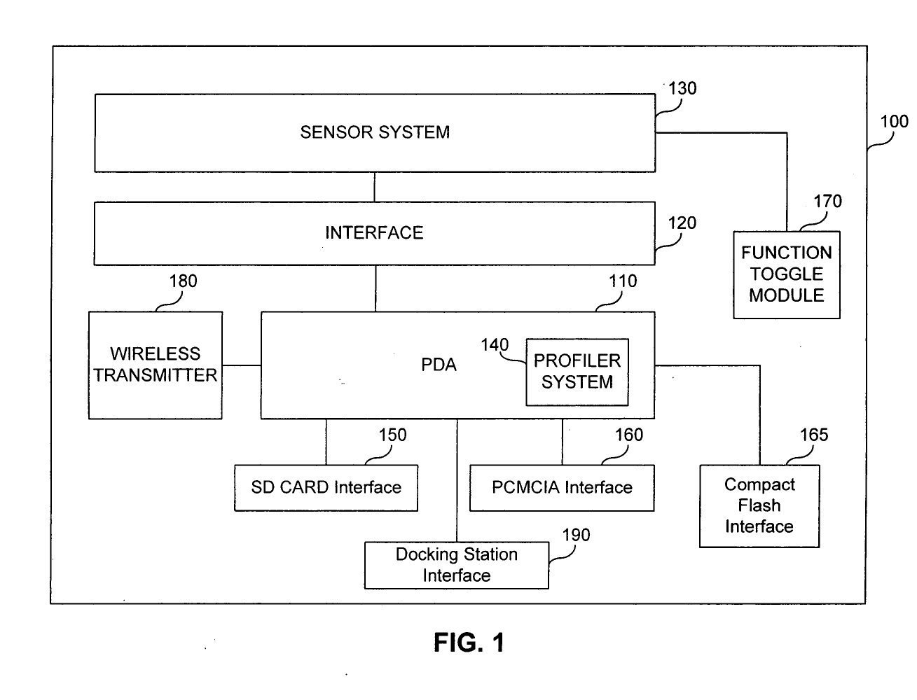

FIG. 1 provides a block diagram of a hand-held personal identification device 100 according to an embodiment of the invention. Hand-held personal identification device 100 includes personal data assistant (PDA) 110, sensor system interface 120, sensor system 130 and profiler system 140. Additionally, hand-held personal identification device 100 includes a variety of communication and control interfaces. These interfaces include one or more of a secure digital (Smart Data (SD) card or SDIO) Interface 150, Personal Computer Memory Card International Association (PCMCIA) Interface 160, compact flash interface 165, function toggle module 170, wireless transmitter 180, and docking station interface 190.

PDA 110 includes a screen for providing a user interface and provides overall system control. PDA 110 provides computing power for system management and information processing. PDAs that are readily available can be used as PDA 110.

Sensor system interface 120 provides an interface for coupling sensor system 130 to PDA 110. Sensor system interface 120 provides connectivity (e.g., pin connections or other wired connections) and interface software to support the electrical coupling of sensor system 130 and PDA 110. The specific pin arrangements and interface software can vary for example, depending on the PDA used for PDA 110. Alternatively, sensor system interface 120 can be a wireless interface, infra-red link, or other type of wireless or wired interface that directly or indirectly couples PDA 110 and sensor system 130.

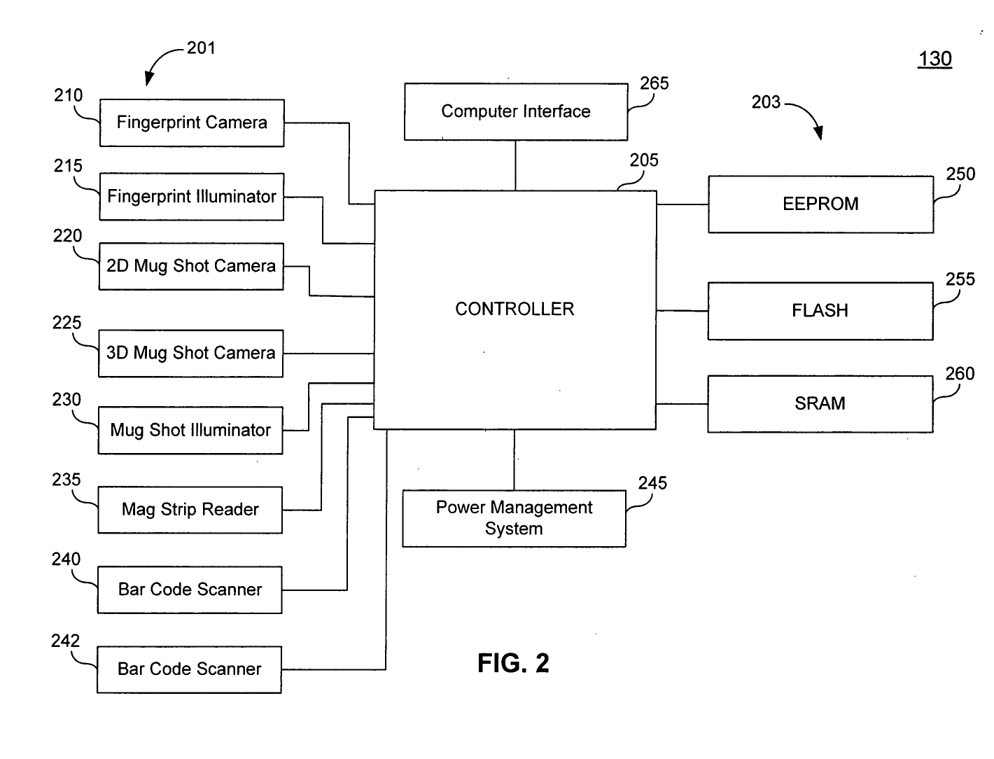

Sensor system 130 gathers biometric and corroborating identity information from individuals. As is discussed with respect to FIG. 2, sensor system 130 can gather a wide variety of biometric information, including but not limited to fingerprint images, two-dimensional facial images (e.g., mug shots), and three-dimensional facial images. Alternatively or in addition to, an iris pattern can be sensed. Sensor system 130 also can collect corroborating identify information such as passport numbers, credit card information, license information et cetera. Sensor system 130 can process requests for biometric and corroborating information from PDA 110 and transmit gathered biometric and corroborating identify information to PDA 110.

Profiler system 140 develops profiles of individuals (profile records) based on biometric information gathered from sensor system 130. Additionally, as explained more fully below, profiler system 140 can combine any combination data such as capture environment data, individual history data, user authentification data and corroborating identity data with the gathered biometric data to create an individual profile. In an embodiment, profiler system 140 is located within PDA 110. In an alternative embodiment, profiler system 140 can be located within sensor system 130. Profiler system 140 can be implemented using software, hardware or a combination of these as will be known by individuals skilled in the relevant arts based on the teachings herein.

The communications and control interfaces of sensor system 100 provide for flexible use of hand-held personal identification device 100. SD Card interface 150, PCMCIA interface 160, and/or Compact Flash interface 165 are coupled to PDA 110, and provide alternative means to provide applications for and control of PDA 110.

Function toggle module 170 supports toggle buttons located on the hand-held personal identification device 100. Function toggle module 170 is coupled to sensor system 130, or can be included within sensor system 130. The toggle buttons allow a user to control the operation of hand-held personal identification device 100 with a single hand. Function toggle module 170 allows an authorized user or administrator to program the toggle buttons for various uses. For example, the buttons can be programmed to allow a user to toggle through the series of steps needed to take a fingerprint image from an individual. In one embodiment, function toggle module 170 is coupled to PDA 110, or can be included within PDA 110.

Wireless transmitter 180 is coupled to PDA 110 and allows hand-held personal identification device 100 to send and/or receive data using any conventional wireless link. For example, a record containing a profile of information collected by and stored in device 100 can be transmitted. A user of hand-held personal identification device 100 may desire, for example, to compare a fingerprint taken from an individual to fingerprints contained in a database at a main processing center. Wireless transmitter 180 can be used to transmit the taken fingerprint image to the main processing center for analysis. Upon the main processing center completing the analysis, wireless transmitter 180 can be used to receive results transmitted by the main processing center.

Docking station interface 190 is coupled to PDA 110 and provides a convenient interface for charging the batteries of hand-held personal identification device 100. Docking station interface 190 can also be used for data synchronization and utilization by other types of processors including but not limited to a personal computer.

1. Sensor System

FIG. 2 provides a block diagram of sensor system 130 according to an embodiment of the invention. Sensor system 130 includes controller 205, a set of biometric and corroborating information capture devices 201, a set of memory devices 203, computer interface 265, and power management system 245.

Controller 205 manages the overall operation of sensor system 130. In an embodiment, controller 205 can be a field programmable gate array (FPGA).

In an embodiment, the set of biometric and corroborating information capture devices 201 includes fingerprint camera 210, fingerprint illuminator 215, two-dimensional (2D) mug shot camera 220, three-dimensional (3D) mug shot camera 225, mug shot illuminator 230, magnetic strip reader 235, and bar code scanner 240. One or more smart card readers 242 (e.g., contact or contactless types of smart card readers can also be coupled to controller 205. The biometric information capture devices include fingerprint camera 210, 2D mug shot camera 220, and 3D mug shot camera 225. In alternative embodiments, hand-held personal identification device 100 can also include other types of biometric capture devices such as, for example, an iris scan device.

Fingerprint camera 210 is coupled to controller 205 and takes print images of fingerprints. Fingerprint illuminator 215 is also coupled to controller 205 and can be used to illuminate a finger for which a print image is being taken. In an embodiment, fingerprint illuminator 215 emits short wave length light (e.g., green light) to reduce ambient light interference to enable usage in direct sunlight without a light shield.

2D mug shot camera 220 is coupled to controller 205 and can take two-dimensional mug shot photos of individuals. 2D mug shot camera 220 produces an image that is a single frame that is captured and stored on hand-held personal identification device 100. Mug shot illuminator 230 is also coupled to controller 205 and can be used to illuminate the face of an individual whose mug shot is being taken. In embodiments, mug shot illuminator 230 can be an infra-red light source or a flash light source.

3D mug shot camera 225 is also coupled to controller 205. 3D mug shot camera 225 and 2D mug shot camera 220 can be used together to generate a 3D mug shot image of an individual that allows for superior analysis of facial features. These examples are illustrative and not intended to limit the invention. Cameras 220 and 225 can also be used, alone or in combination, to capture any feature (face, head, or other body part), an entire body, or other image (picture of passport, document, etc.).

Corroborating information capture devices include magnetic strip reader 235 and bar code scanner 240. These devices can be used to gather corroborating information regarding an individual. For example, magnetic strip reader 235 can be used to read a magnetic strip on a credit card or personal identification card to gather personal information about an individual. Also, bar code scanner 240 can be used to read the bar code information on a United States passport, for example, to gather information about an individual. In one embodiment, hand-held personal identification device 100 can then transmit the passport information to a main processing center. The main processing center could then transmit identifying information, including a stored fingerprint image, to hand-held personal identification device 100 that could be compared to a fingerprint image taken by hand-held personal identification device 100 to verify the identify of an individual.

In an embodiment, the set of memory devices 203 includes EEPROM 250, FLASH 255 and SRAM 260. Each of these memory devices is coupled to controller 205. Secure digital (SD) memory, RAM, and/or PROM memory can also be used. These types of memory are illustrative and not intended to limit the present invention. The memory devices can be used to store program information and data collected by the set of biometric and corroborating information capture devices 201, as will be known by individuals skilled in the relevant arts based on the teachings herein. In an embodiment, sensor system 130 stores calibration and operating parameters information for hand-held personal identification device 100 in one or more of its memory device.

Computer interface 265 provides an interface to allow sensor system 130 to communicate with a PDA, such as PDA 110. Computer interface 265 is coupled to controller 205. In the embodiment provided, it would also be coupled to sensor system interface 120. Power management system 245 manages the power needed for sensor system 130. Power management system 245 can include a power source control module that determines whether AC or DC power should be used. Additionally, power management system 245 can include a battery, such as a lithium ion battery, a battery status indicator, and a battery charger system. Power management system 245 is coupled to controller 205.

2. Profile System

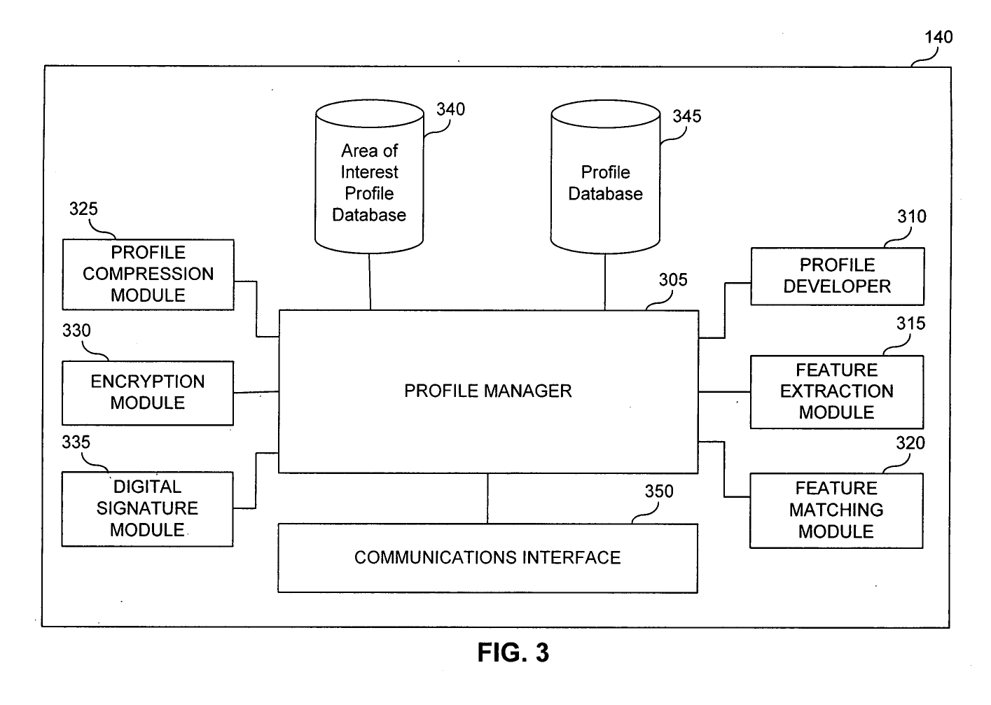

FIG. 3 is a block diagram of profiler system 140 according to an embodiment of the invention. Profiler system 140 includes profile manager 305, profile developer 310, feature extraction module 315, feature matching module 320, profile compression module 325, encryption module 330, digital signature module 335, area of interest profile database 340, profile database 345, and communications interface 350.

Profile manager 305 controls the overall operation of profile system 140. Profile developer 310 develops profiles for individuals being processed. Profile developer 310 combines biometric information that is taken from an individual with supplementary data to create a profile record for further processing such as, for example, internal analysis by hand-held personal identification device 100 or transmittal for external analysis and storage. Supplementary data can include, but is not limited to, capture environment data, individual history data, user authentification data, and corroborating field identity data. A profile record developed by profile developer 310 can include, but is not limited to, any combination of the types of data described herein. The specific approaches to developing a profile will be application specific.

In an embodiment, capture environment data includes, for example, date, time, and location information at the location where biometric data is being gathered. Individual history data includes, for example, general information about an individual's movements, activities, police records, et cetera. The specific data used would be application specific.

In one embodiment, user authentification data is collected and stored by hand-held personal identification device 100. This data includes, for example, data from the user (e.g., a security officer) to authenticate the use of hand-held personal identification device 100. User authentification data can include, for example, the name of the user, an identification password for the user, a digital signature of the user, et cetera.

In an embodiment, corroborating field identity data can also be collected and stored by hand-held personal identification device 100. This data includes, for example, identity information gathered about an individual other than through the biometric capture devices of hand-held personal identification device 100. For example, information taken from a passport bar code is one type of corroborating field identify data. Other types of corroborating field identify data will become apparent to those skilled in the relevant arts given the description herein.

There are many uses for hand-held personal identification device 100. In an embodiment, hand-held personal identification device 100 is used, for example, to provide additional airport security through random checks of airport personnel. In this situation, screening may occur at different locations during the course of a day, week, et cetera. The individual history data can identify where an individual was screened such as, for example, at a baggage check location, at a fueling area, or at various terminals. This information could then be used to confirm whether the individual was supposed to be in the particular areas or whether a pattern was developing that suggested the individual was involved in an unauthorized activity. This example use is only illustrative and not intended to limit the invention.

Feature extraction module 315 extracts features from biometric images so they can be efficiently stored (e.g., in profile records) and analyzed. In an embodiment, feature extraction module 315 can also include image scaling and correction capabilities to enhance biometric images.

Feature matching module 320 compares features of biometric images taken by hand-held personal identification device 100 with features of stored images or images received over wireless transmitter 180.

Profile compression module 325 compresses profiles for efficient storage and transmittal.

Encryption module 330 encrypts profiles for storage and transmittal.

Digital signature module 335 supports the receipt of digital signatures through a screen on PDA 110 or receipt through another means.

Profile database 345 stores profiles that are developed by profile developer 310 or received from another source. Profile database 345 can be used, for example, to store profiles. These profile records can be added, deleted, modified, or updated. The profile records can also be transmitted to another device by wireless transmitter 180.

Area of interest profile database 340 can be used to store sets of profiles that are of interest for a particular application. For example, an airport security audit firm may only be interested in comparing airport personnel biometric information collected from individuals with profiles of known terrorists. The profiles of known terrorists could be loaded into area of interest profile database 340 to provide for local analysis without the need to send information to a remote processing center.

3. Further Embodiments

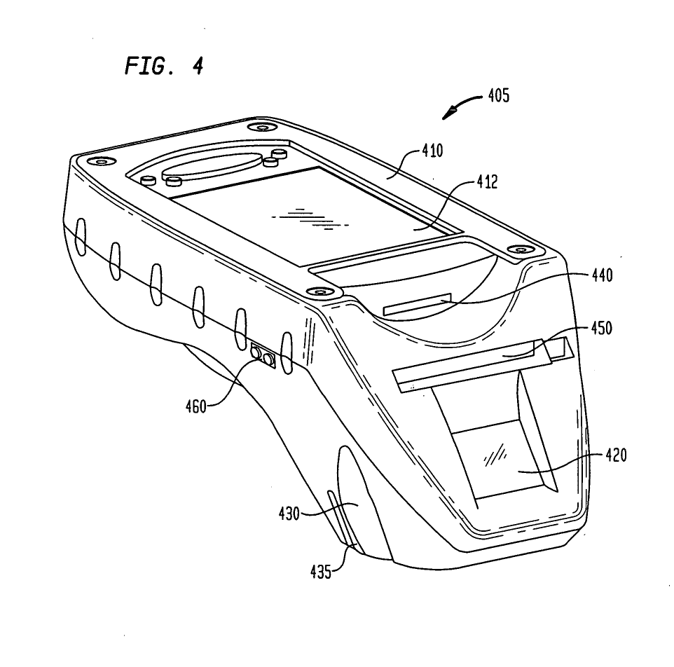

FIG. 4 is a diagram of a hand-held personal identification device 405 according to an embodiment of the invention. As can be seen in FIG. 4, hand-held personal identification device 405 includes a PDA 410 with a screen 412, a fingerprint scanner (print scanner) 420, a mug shot camera 430, a magnetic strip reader 435, a SD card slot 440, a PCMCIA card slot 450, and a toggle function button 460. In embodiments, hand-held personal identification device 405 includes a stylus storage feature (not shown) for efficiently storing a stylus used to write on screen 412 of PDA 410.

In an embodiment, one or more toggle function button(s), such as toggle function button 460, are located on each side of hand-held personal identification device 405. Toggle function button 460 is positioned such that a user can hold hand-held personal identification device 405 in one hand, and with the thumb of the same hand, toggle the functions of hand-held personal identification device 405 by pressing toggle function button 460. Including toggle function buttons on both sides of hand-held personal identification device 405 facilitates both right hand and left hand usage. In an embodiment, adjustable hand straps (not shown) can be used to further simplify use of hand-held personal identification device 405.

To facilitate ease of use, the fingerprint capture surface of fingerprint scanner 420 is positioned at an oblique angle to screen 412 of PDA 410. Mug shot camera 430 is positioned at an oblique angle to screen 412 of PDA 410 to facilitate usage of screen 412 to monitor the image capture process.

In embodiments, fingerprint scanner 420 include features that improve its robustness. In one embodiment, fingerprint scanner 420 includes a silicon pad on a platen surface to provide for enhanced fingerprint images. In some embodiments, hand-held personal identification device 405 supports dark field illumination, bright field illumination, or both. In embodiments, fingerprint scanner 420 also supports platen heating and/or cooling. These features and others described herein enable hand-held personal identification device 405 to be used in a wide variety of environmental conditions.

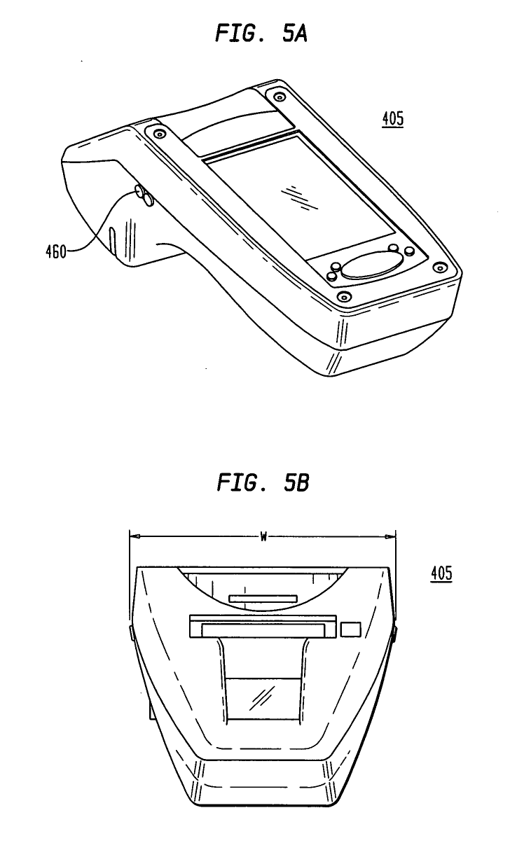

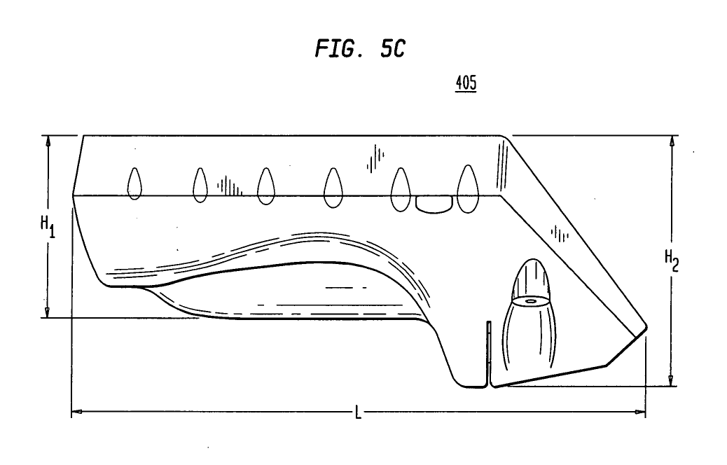

FIGS. 5A-5C further illustrate hand-held personal identification device 405. FIG. 5A is a second perspective view of hand-held personal identification device 405 that shows a second toggle function button 460. FIG. 5B is an end view of the hand-held personal identification device 405 that shows hand-held personal identification device 405 has a width W. FIG. 5C is a side view of the hand-held personal identification device 405 that shows hand-held personal identification device 405 has a length L, a first height H₁, and a second height H₂. In one embodiment, hand-held personal identification device 405 has a width W of about 4 inches, a length L of approximately 8.4 inches, a height H₁, where a user would grasp hand-held personal identification device 405, of about 2.75 inches, and a height H₂, where fingerprint scanner 420 and mug shot camera 430 are located, of about 4 inches. However, these dimensions are only example dimensions and not intended to limit the scope of the invention.

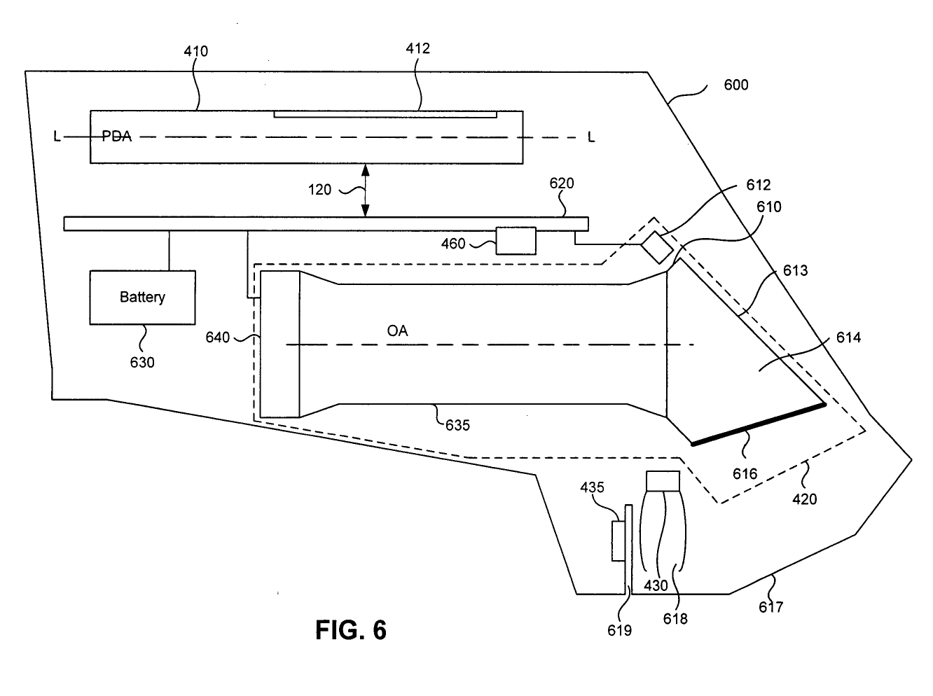

FIG. 6 is a schematic diagram depicting selected components of hand-held personal identification device 405 enclosed by a housing 600. The enclosed components include PDA 410, fingerprint scanner (print scanner) 420, mug shot camera 430, magnetic strip reader 435, a circuit board 620, and a battery 630.

As noted above, PDA 410 includes screen 412 that is used for communicating with a user via, for example, a graphics user interface (GUI). PDA 410 is coupled to circuit board 620 by interface 120. Interface 120 enables PDA 410 to be used to operate, for example, fingerprint scanner 420, mug shot camera 430, and magnetic strip reader 435.

As shown in FIG. 6, fingerprint scanner 420 includes an illumination source 612, a prism 614, focal optics 635, and a camera 640. Illumination source 612 and camera 640 are coupled to circuit board 620. In an embodiment, the optical axis of focal optics 635 is parallel to a longitudinal axis L of PDA 410, as shown in FIG. 6, in order to achieve a compact design for hand-held personal identification device 405.

In an embodiment of fingerprint scanner 420, light from illumination source 612 is injected into prism 614 through an illumination injection surface 610 that is not directly imaged by focal optics 635 and camera 640. The injected light travels across prism 614 and hits a highly reflective surface 616 of prism 614. When this light hits highly reflective surface 616, it is scattered and becomes diffused. Some of the diffused light remains in total internal reflection within prism 614 and is reflected off the inside of platen surface 613 of prism 614. A print pattern made up of ridges and valleys may be placed on platen surface 613 through an opening in housing 600. Light incident on platen 613 is then reflected or absorbed depending upon whether the light is incident at a ridge or valley and the angle of incidence. In this way, an image of a print pattern made up of light totally internally reflected at platen 613 passes out of prism 614 along optical axis OA for detection. The diffused light reflected off the inside of platen surface 613 is imaged by focal optics 635 and camera 640. In other embodiments of hand-held personal identification device 405, other types of fingerprint scanners using bright-field or dark-field illumination techniques are used.

In one embodiment, illumination source 612 emits light at a wavelength (e.g., green) that reduces ambient light interference and enables fingerprint scanner 420 to be used in direct sunlight without a light shield over the fingerprint capture surface or platen surface 613 of prism 614.

Mug shot camera 430 can be any camera appropriately sized to fit within housing 600. As described herein, mug shot camera 430 can be used to obtain two-dimensional (2D) images and/or three-dimensional (3D) images. Mug shot camera 430 is coupled to circuit board 620 via leads (not shown). As shown in FIG. 6, housing 600 includes a recess 618 to accommodate the field-of-view of mug shot camera 430.

In one embodiment, mug shot camera 430 is a monochromatic camera. In another embodiment, mug shot camera 430 is a color camera. In still other embodiments, hand-held personal identification device 405 includes two mug shot cameras 430.

In an embodiment, mug shot camera 430 is a charge-coupled device (CCD) camera having a Bayer pattern filter. Because the pixel sensors in a CCD camera are essentially monochromatic the pixels respond primarily to the intensity of the light falling on them, regardless of the frequency (color) of the light. To make the pixel sensors sensitive to different colors of light, a filter is placed over each pixel sensor during manufacturing. This makes each of the pixel sensors sensitive, for example, to one of the primary colors red, green, or blue. Because a given pixel sensor has only one filter, in a given CCD camera, not all of the pixel sensors are used for each color.

As described herein, in embodiments, mug shot camera 430 is used to obtain multiple two-dimensional facial images, from slightly different perspectives, to generate data for a 3D facial recognition algorithm. The 3D facial data is combined with other biometric data, such as fingerprint data, thereby improve the accuracy of identification. In one embodiment, two separate mug shot cameras 430 and lens (not shown) are focused at a person of interest, along different optical axes, to create a difference of perspective. In this embodiment, there may be one monochromatic and one color imaging camera. In another embodiment, a single mug shot camera 430 is used with a reflective element and a mechanism for blocking one image path, so that the same image sensor can be used to collect data from both perspectives. Alternatively, differential optical band pass filtering may be applied to obtain two perspective views.

Magnetic strip reader 435 can be any known magnetic strip reader. Magnetic strip reader 435 is located adjacent to a slot 619 in housing 600 to facilitate the reading of cards such as, for example, credit cards and drivers license that include a magnetic strip containing data, which can be used in identifying an individual. Magnetic strip reader 435 is coupled to circuit board 620 by leads (not shown).

In an embodiment, a bar code scanner (not shown) is included at a surface 617 of housing 600. The bar code scanner can be used to read bar code information, for example, on a United States passport to gather information about an individual. The bar code scanner, when present, is coupled to circuit board 620. In another embodiment, a mug shot illuminator (not shown) is included at surface 617 of housing 600. The mug shot illuminator illuminates an individual, for example, with a flash or infrared illumination source when using mug shot camera 430. The mug shot illuminator, when present, is coupled to circuit board 620. Both the bar code reader and/or the mug shot illuminator, however, can be located at different locations without departing from the invention.

A battery 630 is coupled to circuit board 620 to provide power for hand-held personal identification device 405. In an embodiment, battery 630 is a rechargeable battery. Battery 630 can be recharged using a conventional power adapter (not shown) that plugs into hand-held personal identification device 405.

As shown in FIG. 6, hand-held personal identification device 405 includes at least one toggle function button 460 coupled to circuit board 620. Toggle function button 460 is positioned such that a user can hold hand-held personal identification device 405 in one hand, and with the thumb of the same hand, toggle the functions of hand-held personal identification device 405 by pressing toggle function button 460.

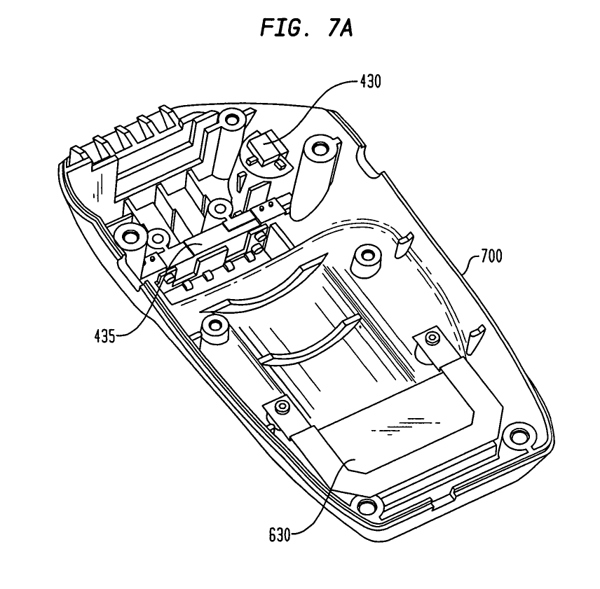

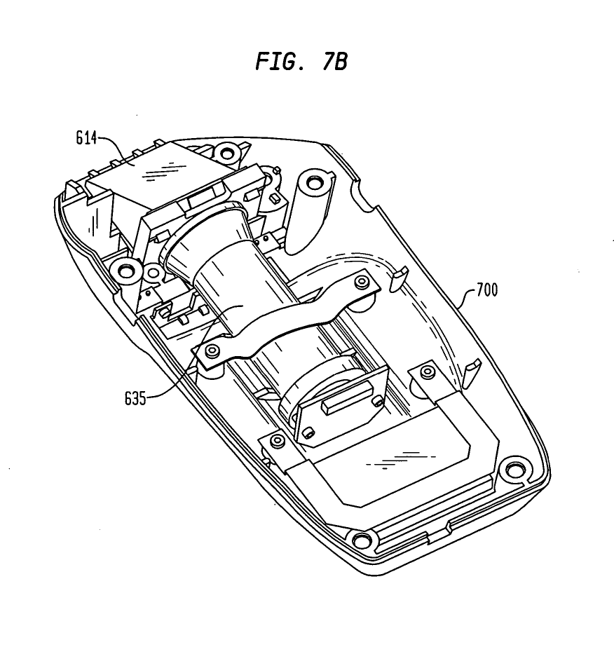

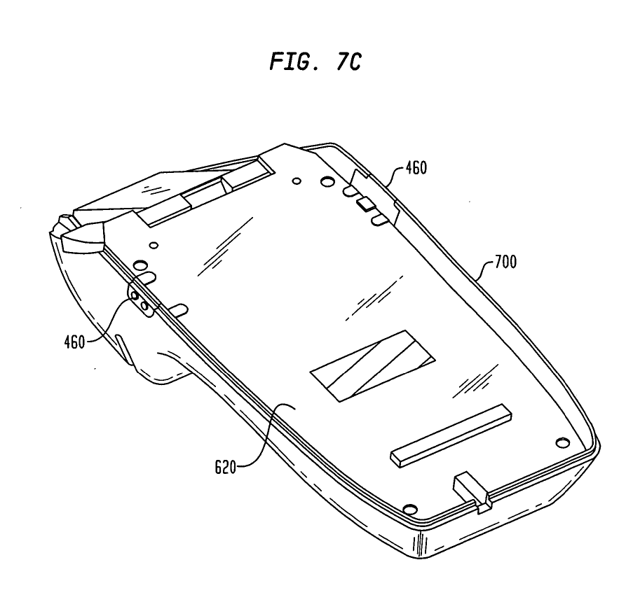

FIGS. 7A-7C are diagrams that further illustrate a bottom portion 700 of housing 600 of hand-held personal identification device 405 according to an embodiment of the invention. FIG. 7A illustrates the location of mug shot camera 430, magnetic strip reader 435, and battery 630 for hand-held personal identification device 405. FIG. 7B illustrated the location of prism 614 and focal optics 635 of hand-held personal identification device 405. FIG. 7C illustrates the location of circuit board 620 and the two toggle function button 460 for hand-held personal identification device 405.

B. Method

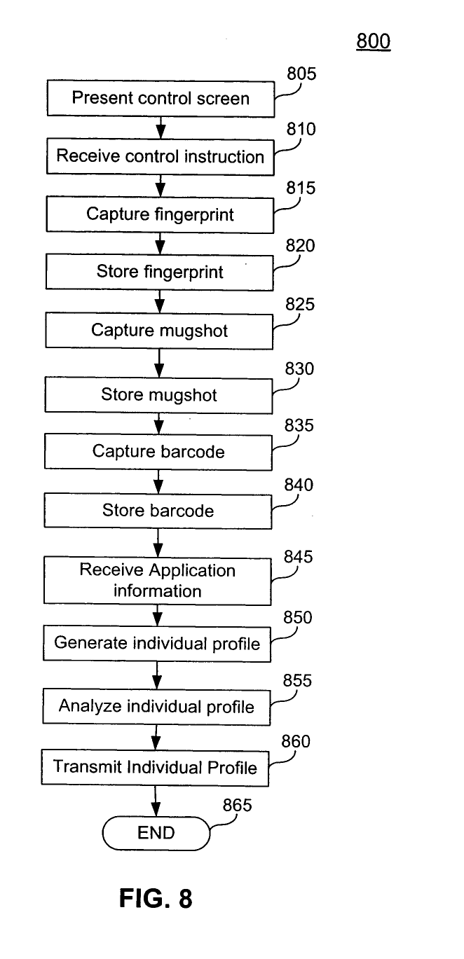

FIG. 8 is a flowchart of a method 800 for capturing and analyzing personal identity information of an individual using a hand-held personal identification device according to an embodiment of the invention. As illustrated in FIG. 8, method 800 includes twelve steps. Method 800 begins with step 805.

In step 805, a control screen is presented to a user. In an embodiment, this is performed using a graphical user interface running on a processor of a PDA.

In step 810, control instructions are received. The hand-held personal identification device can receive control instructions from a user entering a choice presented to the user via a graphical user interface. Control instruction also can be received via a function toggle button of the hand-held personal identification device.

In step 815, a fingerprint image is captured by the hand-held personal identification device.

In step 820, the captured fingerprint image is stored. In an embodiment, the fingerprint is stored in a memory associated with the sensor system of the hand-held personal identification device. The fingerprint also can be stored in a memory associated with the PDA of the hand-held personal identification device.

In step 825, a mug shot image is captured. The mug shot is captured using one or more mug shot cameras of the hand-held personal identification device. The mug shot can be a 2D image, multiple 2D images, or a 3D image. Several images can be captured and stored like a Best Shot Selector (BSS) mode in digital cameras.

In step 830, the mug shot image is stored. In an embodiment, the mug shot image is stored in a memory associated with the sensor system of the hand-held personal identification device. The mug shot image also can be stored in a memory associated with the PDA of the hand-held personal identification device.

In step 835, bar code information is captured. The bar code information is captured using a bar code scanner of the hand-held personal identification device.

In step 840, the barcode information is stored. In an embodiment, the bar code is stored in a memory associated with the sensor system of the hand-held personal identification device. The bar code also can be stored in a memory associated with the PDA of the hand-held personal identification device. In an alternative embodiment, a magnetic strip, for example, on a credit card or license is read by a magnetic strip reader to gather information.

In step 845, application information is received. This information can include any desired supplementary information such as, for example, the time and date fingerprint and/or mug shot were captured, the name of the individual capturing the fingerprint and/or mug shot, the location when the fingerprint and/or mug shot were captured, et cetera.

In step 850, an individual profile is generated. In an embodiment, a profile developer of the hand-held personal identification device combines the captured biometric data with the application information to form the individual profile (record).

In step 855, the individual profile is analyzed. In an embodiment, a feature matching module of the hand-held personal identification device compares the individual profile to profiles stored in area of interest profile database. Alternatively, the individual profile might be compared to profiles at a central or main processing center.

In step 860, the individual profile is transmitted, for example, to a central or main processing center for processing for analysis and/or long-term storage. In an embodiment, a record containing a profile is transmitted. Such a profile record can be encrypted, sent over a secure link, or otherwise made secure when transmitting the profile record.

C. Distributed Control

1. System

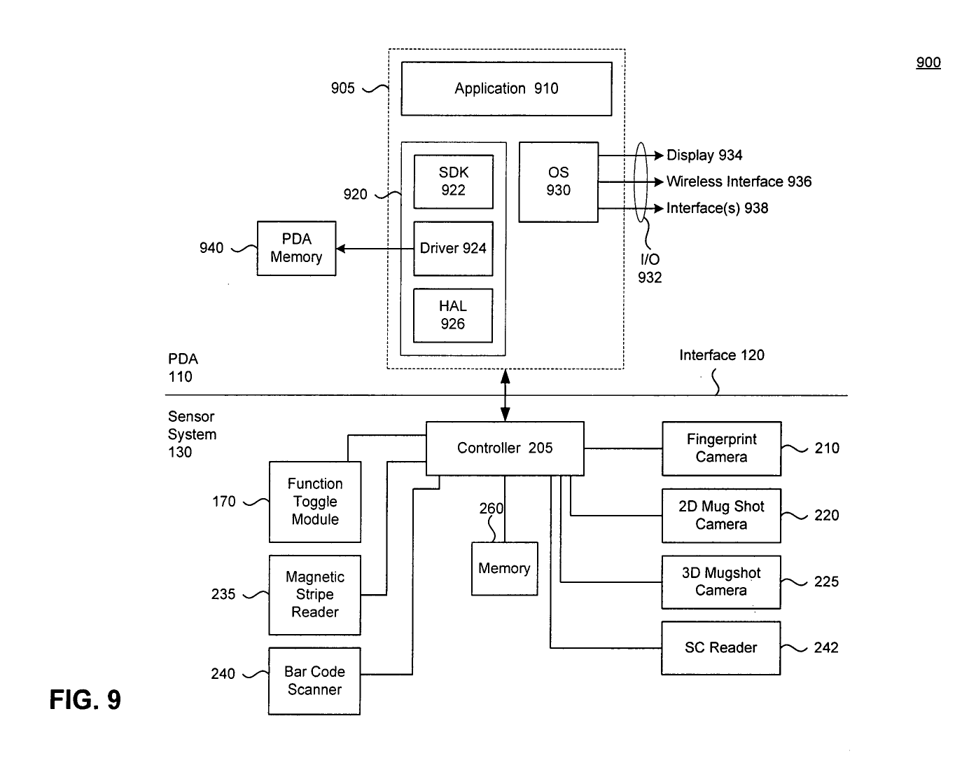

FIG. 9 is a block diagram of a distributed control system 900 for a hand-held personal identification device according to an embodiment of the invention. As shown in FIG. 9, distributed control system 900 includes features that reside in both PDA 110 and sensor system 130. The features of distributed control system 900 residing within PDA 110 include software 905, input/output (I/O) devices 932, and memory 940. The features of distributed control system 900 residing within sensor system 130 include controller 205, function toggle module 170, fingerprint camera 210, 2D mug shot camera 210, 3D mug shot camera, magnetic strip reader 235, and bar code reader 240.

In an embodiment, software 905 includes application software 910, hardware interface software 920, and operating system (OS) software 930. The hardware interface software includes, for example, software development kit (SDK) software 922, one or more software drivers 924, and/or hardware abstraction layer (HAL) software 926. Software 905 interfaces with I/O devices 932, memory 940, and controller 205. I/0 device 932 include, for example, a display 934, a wireless interface 936 and/or other interfaces 938 (e.g., a stylus used with display 934 or buttons on the face of PDA 110).

Controller 205 is a combination of hardware, firmware and/or software that is responsive to inputs/commands from PDA 110 and function toggle module 170. These inputs/commands determine, for example, which sensor of sensor system 130 is actively collecting data and what data is passed to PDA 110 via interface 120. As shown in FIG. 9, the sensors of sensor system 130 include fingerprint camera 210, 2D mug shot camera 210, 3D mug shot camera, magnetic strip reader 235, and bar code reader 240. Other embodiments may include fewer sensors than this or more sensors than this.

In an embodiment, function toggle module 170 includes a function toggle button (see, e.g., function toggle button 460 in FIG. 4), which when depressed causes controller 205 to cycle through the various sensors of sensor system 130, thereby determining which sensor is actively collecting data. Depressing the function toggle button a selected number of times in a predetermined period of time, or holding-in the function toggle button for a predetermined period of time, can then be used to trigger controller 205 to capture data with the active sensor. Similar commands can be given to controller 205 from PDA 110, for example, by having application software 910 prompt a user for an input command and then sending an appropriate command to controller 205 based on the user's input.

Memory 260 is coupled to controller 205 and is used to store data/information obtain by one or more of the sensors of sensor system 130.

2. Method

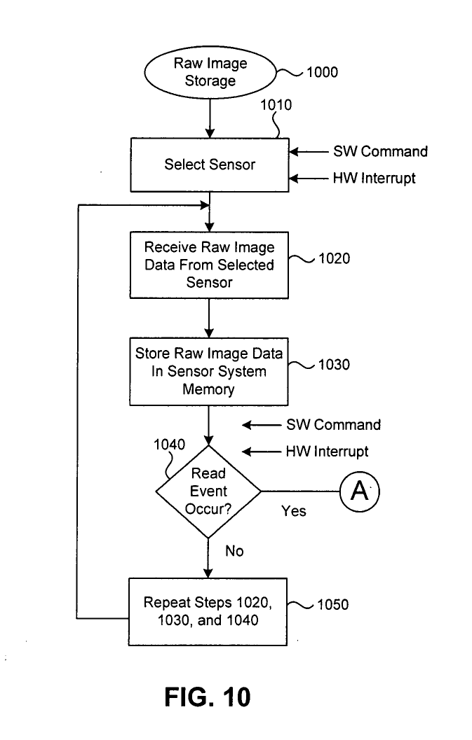

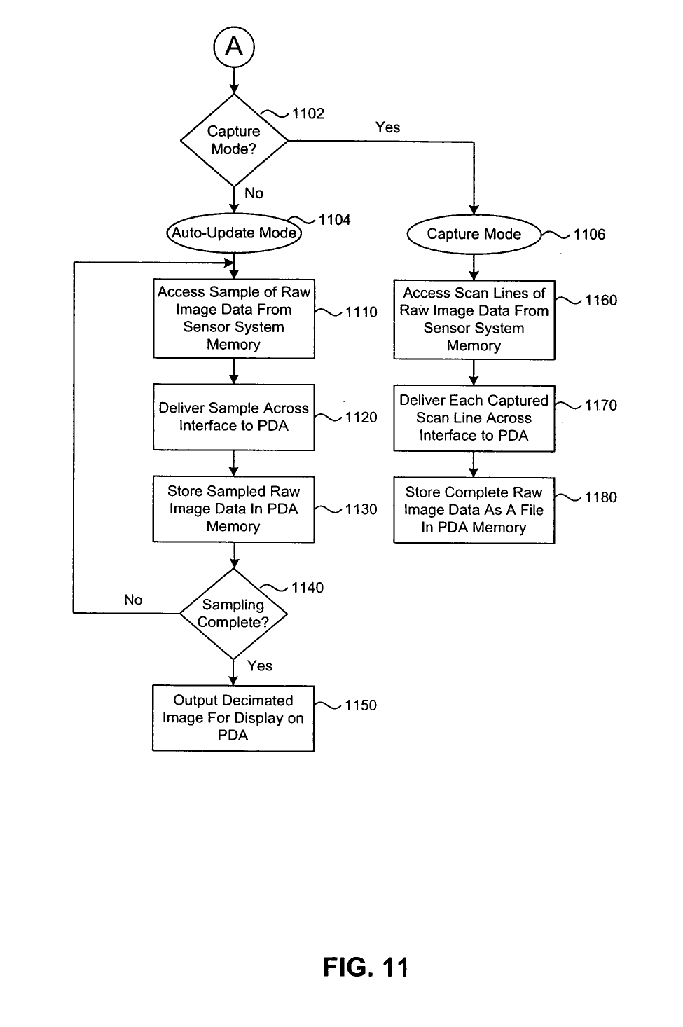

The operation of distributed control system 900 is further illustrated by the steps of the method shown in FIGS. 10 and 11.

FIGS. 10 and 11 depict a flow chart that illustrates the steps of a method 1000 for obtaining identification data according to an embodiment of the invention. Method 1000 is directed particularly to capturing and storing image data such as, for example, fingerprint images using a fingerprint camera and/or mug shot images using a mug shot camera. Steps similar to those of method 1000 can be used to obtain other types of data such as, for example, data from a magnetic strip using a magnetic strip reader or data from a bar code using a bar code scanner.

Method 1000 starts with step 1010. In step 1010, a sensor is selected. As shown in FIG. 10, the sensor selection command can be generated by software or hardware. This step is performed, for example, using distributed control system 900 when a selection command is provided to controller 205 by either PDA 110 or the function toggle button of function toggle module 170.

In step 1020, raw image data is received from the sensor selected in step 1010. This step is performed, for example, using distributed control system 900 when raw image data is received at controller 205 from one of the sensors such as, for example, fingerprint camera 210 or mug shot camera 220.

In step 1030, the raw image data received in step 1020 is stored in memory. This step is performed using distributed control system 900 when raw image data is received at controller 205 is stored in memory 260 of sensor system 130. For example, controller 205 may simply provide a write instruction and a memory address such that raw image data captured at the selected sensor is written to a desired location in memory 260.

In step 1040, a decision is made whether a read event (command) has occurred. If a read event or command has occurred, control is passed to step 1102 (see FIG. 11). If a read event or command has not occurred, control is passed to step 1050. As with the sensor selection command in step 1010, the read event or command can be generated by software or hardware.

In step 1050, steps 1020, 1030, and 1040 are repeated in a loop. In this way, raw image data captured in a selected sensor is written to and stored in memory 260. Depending upon the size of memory 260, more recent captured image data can be written over older data so that memory 260 keeps the most recent image captured by a selected sensor. Alternatively, for larger memory sizes, different memory regions or locations can be used to store multiple captured images.

According to a further feature, distributed control system 900 provides two different modes of image data transfer (auto-update and capture) across interface 120 between sensor system 130 and PDA 110. Auto-update mode allows samples of raw data to be stored in sensor system memory and repeatedly output across interface 120 for storage in PDA 110. In this way, a low resolution image (also called decimated image) can be displayed quickly on PDA 110. Capture mode allows scan lines of raw image data to be stored in sensor system memory and later output across interface 120 so that a complete high resolution image data file can be stored in PDA 110.

Referring now to FIG. 11, as noted above, when a read event or command has occurred, control is passed from step 1040 to step 1102. In step 1102, a decision is made whether method 1000 should perform steps associated with an auto-update mode 1104 or steps associated with a capture mode 1106. If steps associated with auto-update mode 1104 are to be performed, control is passed from step 1102 to step 1110. If steps associated with capture mode 1106 are to be performed, control is passed from step 1102 to step 1160.

When using distributed control system 900, the auto-update mode and the capture mode are selected, for example, using either the I/O devices of PDA 110 or the function toggle button of function toggle module 170. In the auto-update mode, a low resolution image is displayed on display 934 to allow a user to assess whether the image is acceptable (e.g., properly centered, desired profile, et cetera). Using a low resolution image (e.g., an image consisting of less than all of the available image pixels) improves the display refresh rate and allows an approximation of a complete image to be viewed. In the capture mode, a high resolution image (e.g., the entire image captured by a sensor of sensor system 130) is stored in the memory of PDA 110 for subsequent processing and/or transmission to a central processing center as part of an individual identification record.

As shown in FIG. 11, the steps associated with auto-update mode 1104 include steps 1110, 1120, 1130, 1140, and 1150. In step 1110, a sample of the raw image data stored in sensor system memory in step 1030 is accessed (read from memory). In step 1120, the sample of the raw image data accessed in step 1110 is delivered (sent) to a PDA. In step 1130, the sample of the raw image data delivered to the PDA in step 1120 is stored in PDA memory. In step 1140, a determination is made whether the sampling is complete (e.g., whether the low resolution image, or any portion of it, is ready to be displayed on the PDA's screen). Once the image, or a selected portion of the image, is ready to be displayed, it is displayed on the PDA screen in step 1150.

The steps associated with capture mode 1106 include steps 1160, 1170, and 1180. In step 1160, the raw image data (complete image) stored in sensor system memory in step 1030 is accessed (read from memory). In step 1170, the raw image data accessed in step 1110 is delivered (sent) to a PDA. In step 1180, the raw image data delivered to the PDA in step 1170 is stored in PDA memory.

The steps associated with auto-update mode 1104 and capture mode 1106 of method 1000 are performed, for example, using a combination of the features of distributed control system 900. For example, SDK 922 acts as an interface between application 910 and HAL 926 and driver 924. Driver 924 controls read and write operations to and from PDA memory 940. HAL 926 acts as an interface between SDK 922, driver 924 and controller 205. Based on the description herein, persons skilled in the relevant arts will understand how distributed control system 900 implements each of the steps associated with auto-update mode 1104 and capture mode 1106.

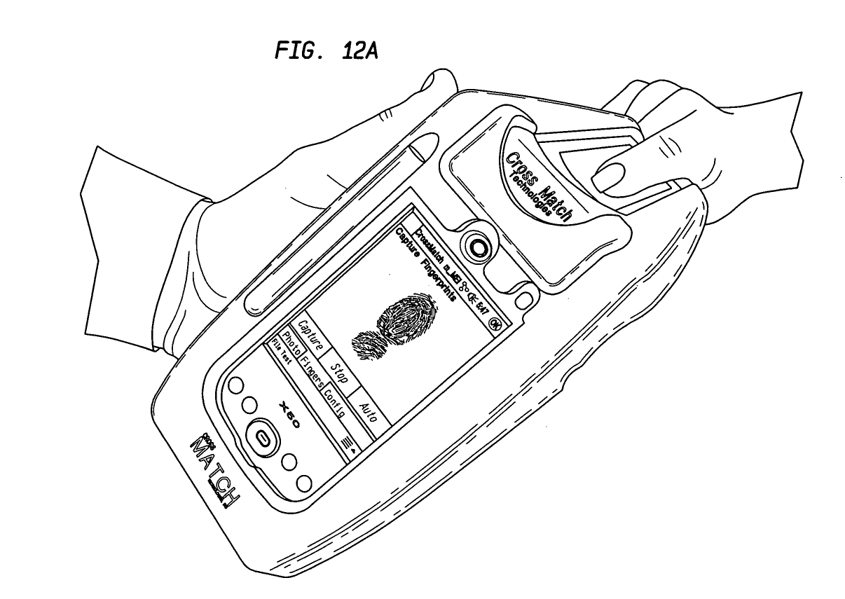

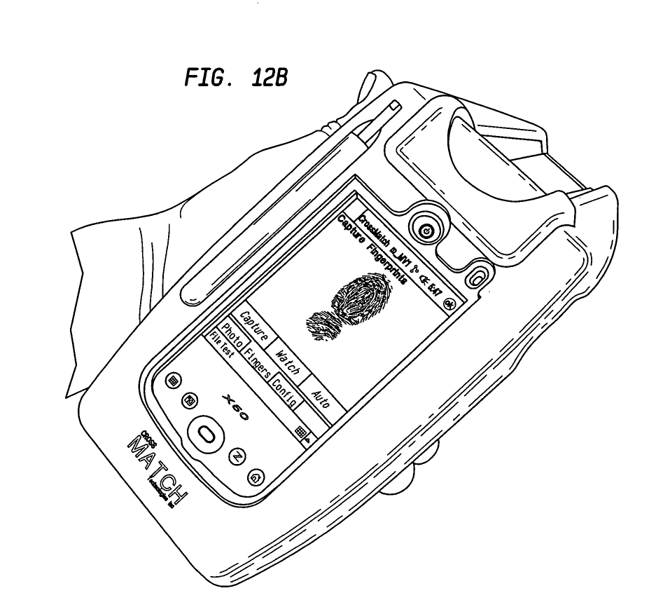

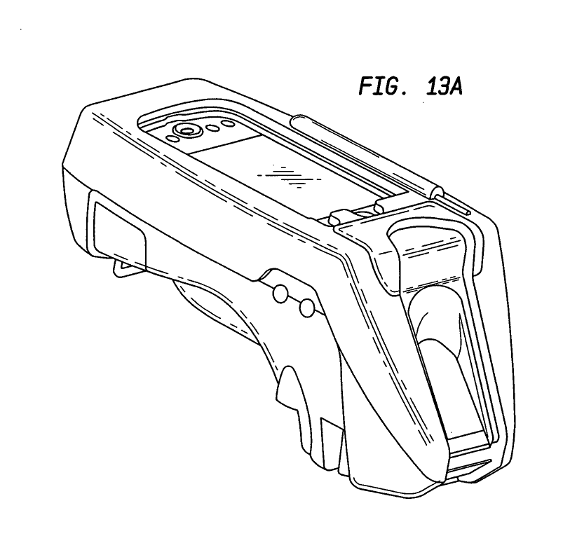

FIGS. 12A and 12B show perspective views of a hand-held personal identification device according to a further embodiment of the invention. In FIG. 12A, a user holds the hand-held personal identification device while a fingerprint of another person is being captured. In FIG. 12B, the captured fingerprint is then displayed on a PDA screen.

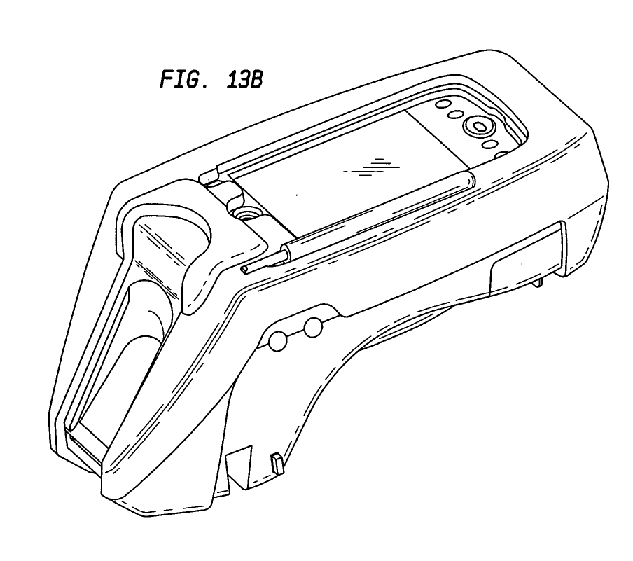

FIGS. 13A and 13B are perspective views from left and right of a hand-held personal identification device with a protective sleeve and multiple toggle buttons (e.g., 2 on both left and right sides) according to a further embodiment of the invention.

Several example environments in which the invention can be used have been described herein. These example environments are only illustrative and not intended to limit the invention. As will become apparent to persons skilled in the relevant arts, the invention can be used in a wide variety of environments including, for example, law enforcement, personnel security, access control, document control, personnel management, et cetera. Thus, the description of the invention herein should not be used to limit the invention to any specific environment(s).

### CONCLUSION

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

What is claimed is:

1. A personal identification device with distributed control, comprising:
a personal data assistant that includes
a first memory, and
a software module that generates control signals; and
a sensor system coupled to the personal data assistant that includes
a controller,
a fingerprint sensor coupled to the controller,
a mug shot sensor coupled to the controller, and
a second memory coupled to the controller,
wherein, in response to a first control signal of the software module, data from one of the fingerprint sensor and the mug shot sensor is stored in the second memory and, in response to a second control signal of the software module, data in the second memory is stored in the first memory.

2. The personal identification device of claim 1, further comprising:
a function toggle device, coupled to the controller, that causes the software module to generate the first control signal and the second control signal.

3. The personal identification device of claim 1, wherein the function toggle device is programmable.

4. The personal identification device of claim 1, further comprising:
a hand-held enclosure for housing the personal data assistant and the sensor system.

5. The personal identification device of claim 4, wherein the function toggle device comprises:
a function toggle button that can be operated by a user's thumb of a hand holding the hand-held enclosure.

6. The personal identification device of claim 1, wherein the fingerprint sensor includes a fingerprint capture surface arranged at an oblique angle to a screen of the personal data assistant.

7. The personal identification device of claim 1, wherein the mug shot sensor is arranged at an oblique angle to a screen of the personal data assistant to facilitate viewing of the screen by a user during image capture.

8. The personal identification device of claim 1, further comprising:
a mug shot illuminator coupled to the controller.

9. The personal identification device of claim 1, further comprising:
a magnetic strip reader coupled to the controller.

10. The personal identification device of claim 1, further comprising:
a bar code scanner coupled to the controller.

11. The personal identification device of claim 1, further comprising:
a profiler system that combines data stored in the first memory with supplementary data to form a profile record.

12. The personal identification device of claim 11, wherein the supplementary data includes capture environment data.

13. The personal identification device of claim 11, wherein the supplementary data includes user authentification data.

14. The personal identification device of claim 11, wherein the supplementary data includes corroborating field identity data.

15. The personal identification device of claim 11, wherein the profiler system comprises a profile compression system to compress a size of the profile record.

16. The personal identification device of claim 11, wherein the profiler system comprises a biometric feature extraction module.

17. The personal identification device of claim 11, wherein the profiler system comprises a biometric feature matching module.

18. The personal identification device of claim 11, further comprising:
a wireless transmitter coupled to the personal data assistant.

19. A method for generating a profile record using a personal identification device comprising a personal data assistant that includes a display and a memory and a sensor system that includes a fingerprint sensor, a mug shot sensor, and a memory, the method comprising:
selecting one of the sensors of the sensor system;
storing an image, output from the selected sensor, in the memory of the sensor system;
displaying, in an auto-update mode of operation of the personal identification device, a low resolution image on the display of the personal data assistant, wherein the low resolution image is formed from the image stored in the memory of the sensor system;
storing, in a capture mode of operation of the personal identification device, the image output from the selected sensor in the memory of the personal data assistant; and
combining supplementary data with image data stored in the memory of the personal data assistant to form a profile record.

20. The method of claim 19, wherein the supplementary data includes capture environment data.

21. The method of claim 19, wherein the supplementary data includes user authentification data.

22. The method of claim 19, wherein the supplementary data includes corroborating field identity data.

23. The method of claim 19, wherein the sensor system includes a magnetic strip reader, the method further comprising:
using the magnetic strip reader to obtain the supplementary data.

24. The method of claim 19, wherein the sensor system includes a bar code scanner, the method further comprising:
using the bar code scanner to obtain the supplementary data.

25. The method of claim 19, wherein the image data of the profile record comprises data representing an extracted biometric feature.

26. A hand-held personal identification device having a compact profile, comprising:
a personal data assistant having a longitudinal axis; and
a sensor system, coupled to the personal data assistant, that includes a print scanner having an optical axis between a prism and a camera of the print scanner, the print scanner being arranged relative to the personal data assistant such that the longitudinal axis and the optical axis are approximately parallel and the personal data assistant is located adjacent to and overlaps the print scanner in a direction perpendicular to the optical axis.

27. The hand-held personal identification device of claim 26, wherein the print scanner includes a fingerprint capture surface arranged at an oblique angle to a screen of the personal data assistant.

28. The hand-held personal identification device of claim 27, wherein the sensor system includes a mug shot camera.

29. The hand-held personal identification device of claim 28, wherein the mug shot camera is arranged at an oblique angle to the screen of the personal data assistant to facilitate viewing of the screen by a user during image capture.

30. The hand-held personal identification device of claim 29, wherein the sensor system includes a magnetic strip reader.
